(19) United States
(12) Patent Application Publication
(10) Pub. No.: US 2024/0042550 A1
(43) Pub. Date: Feb. 8, 2024

(54) PRODUCTION OF BIPOLAR PLATES FROM SHEET METAL FOILS

(71) Applicant: TRUMPF Laser- und Systemtechnik GmbH, Ditzingen (DE)

(72) Inventors: Robert Ganter, Gerlingen (DE); Christoph Scharfenberg, Rottenburg am Neckar (DE)

(21) Appl. No.: 18/489,109

(22) Filed: Oct. 18, 2023

Related U.S. Application Data
(63) Continuation of application No. PCT/EP2022/060271, filed on Apr. 19, 2022.

(30) Foreign Application Priority Data
Apr. 20, 2021 (DE) 102021203928.6

(51) Int. Cl. B23K 26/26; H01M 8/0206; H01M 8/0228; H01M 8/0297

(52) U.S. Cl. CPC B23K 26/26; H01M 8/0206; H01M 8/0228; H01M 8/0297

(57) ABSTRACT

A method for producing bipolar plates for production of fuel cells includes uncoiling a first sheet metal foil from a first sheet metal foil coil, and uncoiling a second sheet metal foil from a second sheet metal foil coil, forming the first sheet metal foil and the second sheet metal foil, allocating the first sheet metal foil and the second sheet metal foil based on formed structures of the first sheet metal foil and the second sheet metal foil, and laser welding the first sheet metal foil and the second sheet metal foil transversely to a feed direction of the first sheet metal foil and the second sheet metal foil in a first joining station. The first joining station mutually compresses the first sheet metal foil and the second sheet metal foil. The method further includes removing bipolar plates from the first sheet metal foil and second sheet metal foil.

### CROSS REFERENCE TO RELATED APPLICATIONS

This application is a continuation of International Application No. PCT/EP2022/060271 (WO 2022/223534 A1), filed on Apr. 19, 2022, and claims benefit to German Patent Application No. DE 10 2021 203 928.6, filed on Apr. 20, 2021. The aforementioned applications are hereby incorporated by reference herein.

### FIELD

Embodiments of the present invention relate to a method for producing bipolar plates from sheet metal foils. Embodiments of the present invention furthermore relate to a device for carrying out such a method.

### BACKGROUND

The production of bipolar plates from sheet metal foils has become known from DE 10 2019 202 493 A1. Formed sheet metal foils are pressed together by two rollers and welded by a laser, whereby the laser beam is aligned in the feed direction of the two rollers.

### SUMMARY

Embodiments of the present invention provide a method for producing bipolar plates for production of fuel cells. The method includes uncoiling a first sheet metal foil from a first sheet metal foil coil, and uncoiling a second sheet metal foil from a second sheet metal foil coil, forming the first sheet metal foil and the second sheet metal foil, allocating the first sheet metal foil and the second sheet metal foil based on formed structures of the first sheet metal foil and the second sheet metal foil, and laser welding the first sheet metal foil and the second sheet metal foil transversely to a feed direction of the first sheet metal foil and the second sheet metal foil in a first joining station. The first joining station mutually compresses the first sheet metal foil and the second sheet metal foil. The method further includes removing bipolar plates from the connected first sheet metal foil and second sheet metal foil.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of the method according to embodiments of the invention and the device according to embodiments of the invention. Details of the method or of the device are illustrated in boxes.

Detailed Description Embodiments of the invention provide a more effective method for producing bipolar plates of a high quality.

According to embodiments of the invention, a method for producing bipolar plates includes the following steps:
A) uncoiling a first sheet metal foil and a second sheet metal foil;
B) forming the two sheet metal foils;
C) allocating the two sheet metal foils based on the forming procedures;
D) laser welding the two sheet metal foils, wherein the sheet metal foils are mutually compressed during laser welding in a first joining station, and wherein the laser beam is aligned transversely, in particular at an angle of more than 60°, preferably at an angle of more than 80°, to the feed direction of the connected sheet metal foils in a first joining station;
E) removing bipolar plates from the connected sheet metal foils.

In the case of one or a plurality of the optional method features described below being used, in an independent aspect of the invention in method step D) the feature that the laser beam is aligned transversely to the feed direction of the sheet metal foils in a first joining station may be omitted.

The method according to embodiments of the invention enables a fast and cost-effective production of bipolar plates.

First, the two blank sheets, which in the formed and joined state represent the integrated channel structure of the bipolar plates, are uncoiled from sheet metal foil coils and precision-formed. The channel geometry of the bipolar plates is created as a result.

Preferably, sheet metal foils with a thickness of less than 1 mm, in particular of less than 0.5 mm, preferably of less than 0.1 mm, are used.

The sheet metal foils on their transport route during the entire process can pass through at least one, in particular different, strain relief(s) and/or compensation section(s).

In order to avoid that the individual parts of the bipolar plates have to be placed in a device and allocated to one another for each operating step (which is needed for welding and removing), the components remain in the material belt, which ensures precise orientation at all times in the production run.

A particularity of the present method herein lies in that the exact position of the components to be welded is precisely known at any time and there is therefore no complexity incurred for handling and allocating these components.

The first joining station allows precise welding of mutually compressed sheet metal foils perpendicular to the extent of the sheet metal foils. The formed portions of the two sheet metal foils are preferably formed in the shape of shells. For welding the formed portions, the latter are preferably compressed to a gap of zero.

The first joining station can be embodied as a press. The adjustable contact pressure can be applied pneumatically, electromechanically, or hydraulically.

The removal in method step E) is preferably carried out by punching.

In a preferred design embodiment of the invention, the laser welding in method step D) is preferably performed through openings of a first mask of the first joining station, wherein the first mask mutually compresses the two sheet metal foils in method step D). The openings of the first mask can have a trapezoidal cross section. The trapezoidal cross section of the openings can taper toward the sheet metal foils.

In the first joining station, a second mask opposite the first mask can be used to mutually compress the two sheet metal foils. Laser welding here can be performed from opposite sides through the first mask and the second mask. The welding process can take place simultaneously, consecutively or alternately.

If masks are used on both opposite sides, closed contours, for example circles, can also be welded and the two sheet metal foils can be reliably mutually compressed in these regions. The closed contours can be distributed between the two masks.

In other words, simultaneous machining of sheet metal foils from both sides is not only desirable in order to reduce machining time. This simultaneous machining is very useful for closed welded contours, as the masks for compressing the sheet metal foils cannot contain closed contours. For this reason, closed contours are ideally welded from both sides, in each case as half-open contours with an overlap. In addition, the distortion of the bipolar plates owing to thermal stresses can be optimized to the lowest extent when energy is input on both sides. The planarity of the welded bipolar plates is an important quality criterion.

The laser welding in method step D) is also preferably performed through openings of the second mask. The openings can have a trapezoidal cross section. The trapezoidal cross section of the openings of the second mask can taper toward the sheet metal foils.

In method step D), a plurality of laser scanners can be used in the first joining station. The scanned fields of the laser scanners can overlap one another. The cycle time of the entire process is determined by the laser welding in method step D). The method can be significantly accelerated by using a plurality of laser scanners.

In addition to the first joining station, a second joining station can be provided. Laser welding of the first sheet metal foil to the second sheet metal foil can be performed in the second joining station. The sheet metal foils can be welded partly in the first joining station and partly in the second joining station. The second joining station allows a significant reduction in cycle time and a consequent significant increase in the productivity of the entire process.

A third mask can be used in the second joining station to compress the two sheet metal foils. Preferably, the laser welding in method step D) is performed through openings of the third mask.

The second joining station can have a fourth mask opposite the third mask to mutually compress the two sheet metal foils, wherein the laser welding in method step D) is performed from opposite sides through the third mask and the fourth mask.

The first joining station and the second joining station can be of identical configuration. This means that in the event of a defect in the first joining station, it is possible to divert to the second joining station without having to stop the entire method.

In a further preferred embodiment of the invention, the sheet metal foils in method step C) are allocated by a first roller, which is polygonal in cross section, and a second roller opposite the first roller, which is polygonal in cross section. The two rollers preferably connect the foils in a form-fitting manner in portions. The two rollers allow an allocation of the formed sheet metal foils.

The geometry of the rollers in profile consists of at least one, in particular radiused, polygon (e.g. hexagon, octagon). In order to avoid stresses in the preformed sheet metal foils, sheet metal foil can be rendered flexible by breakouts at the transition between two bipolar plates.

Method step C) represents an independent aspect of the present invention. The other features and method steps described herein can be combined with method step C) in an arbitrary manner.

When forming in method step B), the first sheet metal foil and/or the second sheet metal foil can be embossed, bent and/or blanked.

The forming in method step B) can be performed in a plurality of steps. Depending on the requirements of the forming process, it may be expedient to divide the embossing of the formed sections into a plurality of steps. These steps are disposed successively in series, whereby the workpieces are transported onward by the sheet metal foils from which the workpiece is removed only at the end of the method.

The method can include the crushing of the scrap skeleton created in method step E).

The bipolar plates are preferably removed from the material strip (consisting of the two sheet metal foils) at the latest possible time.

The scrap skeleton is preferably crushed, including the rejected bipolar plates potentially contained therein. In highly integrated manufacturing processes it is important that good parts are not mixed with reject parts. Considerable efforts are often made to technically preclude this mixing. The immediate destruction of reject parts takes this aspect into account.

The method can include carrying out automated quality control.

Alternatively or additionally, the bipolar plates in the material strip can also be fed to further method steps, in particular coating, sealing and/or cleaning.

The two sheet metal foils are preferably guided so as to extend vertically at least in method step D). This allows simultaneous welding from two sides in a manner which is simple in terms of construction. This ensures a production process that is optimized for cycle time and quality.

The sheet metal foils are furthermore preferably guided so as to extend vertically in a plurality of, in particular all, method steps.

Embodiments of the invention furthermore relate to a device for carrying out a method described herein.

Further advantages of the embodiments of the invention are derived from the description and the drawing. Similarly, according to embodiments of the invention, the features mentioned above and those still to be further presented may be used in each case individually or together in any desired combinations. The embodiments shown and described are not to be understood as a final enumeration, but rather have an exemplary character for the description of the embodiments of the invention.

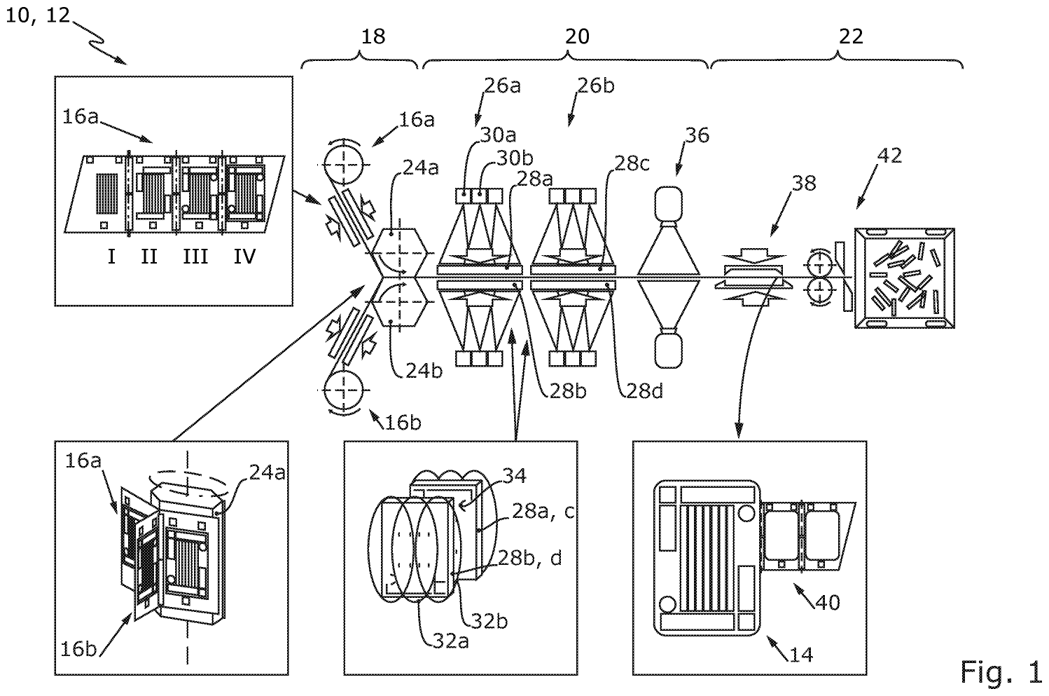

First, the bipolar plate structures are formed in the sheet metal foils 16a,b. In FIG. 1, this is illustrated by way of example in a plurality of steps I to IV.

Subsequently, the sheet metal foils 16a,b are converged by a polygonal first roller 24a, which is polygonal in cross section, and a second roller 24b, which is polygonal in cross section.

The welding of portions of the sheet metal foils 16a,b joined in a form-fitting manner is performed in a first joining station 26a and an optional second joining station 26b. The first joining station 26a has a first mask 28a and a second mask 28b. The second joining station 26b has a third mask 28c and a fourth mask 28d. The masks 28a-d mutually compress the sheet metal foils 16a,b, in particular to a zero gap.

The welding is achieved by a plurality of laser scanners, of which in FIG. 1 only the laser scanners 30a, 30b are provided with a reference sign for reasons of clarity. The laser scanners 30a,b can have overlapping scanned fields, of which in FIG. 1 only the scanned fields 32a, 32b are provided with a reference sign for reasons of clarity.

The laser beams impact the sheet metal foils 16a,b through openings 34 of the masks 28a-d. For reasons of clarity, only one opening 34 is provided with a reference sign in FIG. 1.

After laser welding 20, quality control 36 can take place.

The welded bipolar plates 14 are removed from the sheet metal foils 16a,b by punching 38. A scrap skeleton 40 (illustrated reduced in size relative to the bipolar plates 14 in FIG. 1) can be crushed in a scrap skeleton shredder 42. The scrap skeleton crushing here can also comprise bipolar plates 14 that did not pass quality control 36.

Embodiments of the invention thus relate to a method 12 for producing bipolar plates 14 for the production of fuel cells, in which method a first sheet metal foil 16a and a second sheet metal foil 16b are formed. Subsequently, the sheet metal foils 16a,b are allocated to one other based on the formed structures. Thereafter, the sheet metal foils 16a,b are mutually compressed in a first joining station 26a, in particular by a first mask 28a, and, welded to one another in portions in particular through openings 34 of the first mask 28a. Finally, the bipolar plates 14 connected to one another are removed from the sheet metal foils 16a,b. Preferably, in the first joining station 26a a second mask 28b is used, welding of the sheet metal foils 16a,b being performed through the openings 34 of the latter, wherein the sheet metal foils 16a,b are mutually compressed between the first mask 28a and the second mask 28b. The planes of the sheet metal foils 16a,b preferably extend vertically in the first joining station 26a. Embodiments of the invention furthermore relate to a device 10 for carrying out such a method 12.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Device
12 Method
14 Bipolar plates
16a,b Sheet metal foils
18 Forming and allocating
20 Laser welding
22 Retrieval and handling of scrap material
24a,b Roller
26a,b Joining station
28a-d Mask
30a,b Laser scanner
32a,b Scanned field
34 Opening
36 Quality control
38 Punching
40 Scrap skeleton
42 Scrap skeleton shredder

1. A method for producing bipolar plates for production of fuel cells, the method comprising:
A) uncoiling a first sheet metal foil from a first sheet metal foil coil, and uncoiling a second sheet metal foil from a second sheet metal foil coil;
B) forming the first sheet metal foil and the second sheet metal foil;
C) allocating the first sheet metal foil and the second sheet metal foil based on formed structures of the first sheet metal foil and the second sheet metal foil;
D) laser welding the first sheet metal foil and the second sheet metal foil transversely to a feed direction of the first sheet metal foil and the second sheet metal foil in a first joining station, wherein the first joining station mutually compresses the first sheet metal foil and the second sheet metal foil; and
E) removing bipolar plates from the connected first sheet metal foil and second sheet metal foil.

2. The method as claimed in claim 1, wherein the laser welding in step D) is carried out through openings of a first mask of the first joining station, wherein the first mask mutually compresses the first sheet metal foil and the second sheet metal foil in step D).

3. The method as claimed in claim 2, wherein in step D), in the first joining station, a second mask opposite the first mask is used to mutually compress the first sheet metal foil and the second sheet metal foil, wherein the laser welding is performed from opposite sides through the first mask and the second mask.

4. The method as claimed in claim 3, wherein the laser welding in step D) is performed through openings of the second mask.

5. The method as claimed in claim 1, wherein in step D), a plurality of laser scanners is used for the laser welding in the first joining station.

6. The method as claimed in claim 1, wherein in step D), the laser welding of the first sheet metal foil to the second sheet metal foil is performed by a second joining station.

7. The method as claimed in claim 6, wherein in the second joining station, a third mask is used to mutually compress the first sheet metal foil and the second sheet metal foil, wherein the laser welding in step D) is performed through openings of the third mask.

8. The method as claimed in claim 6, wherein the first joining station and the second joining station are of identical configuration.

9. The method as claimed in claim 1, wherein the allocating of the first sheet metal foil and the second sheet metal foil in step C) is carried out by a first roller that is polygonal in cross section, and a second roller opposite the first roller that is polygonal in cross section, wherein the first roller and the second roller connect the first sheet metal foil and the second sheet metal foil in a form-fitting manner in portions.

10. The method as claimed in claim 1, wherein the first sheet metal foil and/or the second sheet metal foil are/is embossed, bent, and/or blanked in portions during the forming in step B).

11. The method as claimed in claim 1, wherein during the forming in step B), the forming takes place in a plurality of successive steps.

12. The method as claimed in claim 1, wherein a scrap skeleton created in step E) is crushed.

13. The method as claimed in claim 1, wherein automated quality control at least of step D) is carried out.

14. The method as claimed in claim 1, wherein the first sheet metal foil and the second sheet metal foil are guided so as to extend vertically at least in step D).

15. A device for carrying out a method as claimed in claim 1.
